(19) United States
(12) Patent Application Publication
(10) Pub. No.: US 2013/0331483 A1
(43) Pub. Date: Dec. 12, 2013

(54) ORGANIC-INORGANIC HYBRID PAINT COMPOSITION

(71) Applicants: Youn Bong Kang, Incheon (KR); Peng Sam Park, Incheon (KR)

(72) Inventors: Youn Bong Kang, Incheon (KR); Peng Sam Park, Incheon (KR)

(73) Assignee: AKZO NOBEL COATINGS INTERNATIONAL B.V., Arnhem (NL)

(21) Appl. No.: 13/993,013

(22) PCT Filed: Dec. 16, 2011
(86) PCT No.: PCT/KR11/09740

§ 371 Date: Aug. 24, 2013

(30) Foreign Application Priority Data
Dec. 17, 2010 (KR) 10-2010-0130321

(51) Int. Cl. C09D 133/12

(52) U.S. Cl. CPC C09D 133/12
USPC 523/454

(57) ABSTRACT

The present invention relates to an organic-inorganic hybrid paint composition comprising (a) an organic resin comprising an acrylic resin, a melamine resin and an epoxy resin; (b) a ceramic resin; and (c) a solvent. The paint composition of the present invention may be easily cured without a curing accelerator unlike conventional paint compositions, and it may form a paint film having generally improved properties of surface hardness and scratch resistance, as well as gloss, adhesion, boil resistance, chemical resistance, and the like.

### FIELD OF THE INVENTION

The present invention relates to an organic-inorganic hybrid paint composition, more specifically to an organic-inorganic hybrid paint composition that may form a paint film having excellent surface hardness and scratch resistance by thermal curing without a curing accelerator.

### BACKGROUND OF THE INVENTION

Recently, in order to protect the surfaces of a mobile phone case, exterior furnishings of household appliances, interior and exterior furnishings of automobiles, exterior furnishings of automobile parts, various display products, and the like, and to prevent scratches on the surfaces, a hard coating (paint film) has been formed using an organic-inorganic hybrid paint composition on the surface of various substrates.

As the organic-inorganic hybrid paint composition, an inorganic filler or an inorganic precursor was added to an organic resin such as acrylic resin, and the like, to form a hard coating layer on the surface of a substrate. In this case, however, although abrasion resistance, durability, chemical resistance and hardness were improved compared to a coating layer formed using an organic resin alone, a turbid coating layer or non-uniform particle is formed due to inorganic particles, and thus, appearance such as gloss was not good.

Thus, a hard coating layer was formed using a paint composition prepared by simply mixing organic resin such as acrylic resin with silicon resin, a kind of inorganic resin, instead of using an inorganic filler or inorganic precursor. In this case, a transparent coating layer having good gloss, and the like compared to the coating layer using an inorganic filler or inorganic precursor may be embodied, and it has excellent heat resistance.

However, the conventional paint composition comprising silicon resin required a curing accelerator to cure the silicon resin, and due to low cross linking density between the silicon resin and the organic resin, a paint film having low surface hardness and scratch resistance was formed on the exterior surface of a mobile phone or household appliances, and the like, and thereby, generating life scratch to reduce product value. Moreover, the conventional paint composition comprising silicon resin did not satisfy properties including adhesion to a substrate, abrasion resistance, gloss, and the like required in this field.

### SUMMARY OF THE INVENTION

The present invention is based on the discovery that if ceramic resin formed by a sol-gel reaction is used, instead of silicon resin, together with organic resin, the composition may be easily cured at a temperature of from about 100˜200° C. without a curing accelerator, and a crosslinking density between the organic resin and the ceramic resin may increase to form a paint film having high surface hardness and excellent scratch resistance.

The present invention provides an organic-inorganic hybrid paint composition comprising (a) an organic resin comprising an acrylic resin, a melamine resin, and an epoxy resin; (b) a ceramic resin; and (c) a solvent.

The composition of the present invention may be easily cured without a curing accelerator unlike the conventional paint compositions comprising silicon resin, by comprising ceramic resin instead of silicon resin together with organic resin.

And, if a paint film is formed using the paint composition of the present invention, a crosslinking density between the organic resin and the ceramic resin may increase, and thus, properties including gloss, adhesion, boil resistance, chemical resistance, abrasion resistance, impact resistance, dip dyeing resistance, and the like, as well as surface hardness and scratch resistance of the paint film may be generally improved.

### DETAILED DESCRIPTION OF THE INVENTION

Hereinafter, the present invention will be explained in detail.

The organic-inorganic hybrid paint composition according to the present invention comprises ceramic resin formed by a sol-gel reaction, as well as an organic resin comprising acrylic resin, melamine resin and epoxy resin. Thereby, unlike the conventional paint composition comprising a silicon resin, curing may be achieved without using a metal catalyst, and a paint film having high surface hardness may be formed due to the high crosslinking density between the ceramic resin and the organic resin.

### Organic Resin

In the organic-inorganic hybrid paint composition of the present invention, the organic resin (a) comprises acrylic resin (a1), melamine resin (a2) and epoxy resin (a3).

To increase crosslinking density with the ceramic resin thereby increasing hardness, the paint composition of the present invention comprises the acrylic resin (a1). Examples of the acrylic resin (a1) are not specifically limited, but it may be preferable to use a polymerization product of (meth)acrylic acid ester, carboxylic acid containing monomers and hydroxyl group containing monomers.

Specific examples of the (meth)acrylic acid ester may include methylacrylate, ethylacrylate, propyl(meth)acrylate, isopropyl(meth)acrylate, n-butyl(meth)acrylate, isobutal(meth)acrylate, n-amyl(meth)acrylate, isoamyl(meth)acrylate, hexyl(meth)acrylate, tert-butyl(meth)acrylate, 2-ethylhexyl(meth) acrylate, cyclohexyl(meth)acrylate, n-octyl(meth)acrylate, isobutyl(meth)acrylate, isooctyl(meth)acrylate, isononyl(meth)acrylate, n-dodecyl(meth)acrylate, benzine(meth)acrylate, cyclooctyl(meth) acrylate, cyclododecyl(meth)acrylate, cyclohexylmethyl(meth)acrylate, stearyl(meth)acrylate, lauryl(meth)acrylate, and the like, but not limited thereto.

And, specific examples of the carboxyl group containing monomer may include (meth)acrylic acid, maleic acid, fumaric acid, itaconic acid, crotonic acid, and the like, but not limited thereto.

And, specific examples of the hydroxyl group containing monomer may include 2-hydroxyethyl(meth)acrylate, 2-hydroxypropyl(meth)acrylate, 3-hydroxypropyl(meth)acrylate, 2-hydroxybutylacrylate, 4-hydroxybutyl(meth)acrylate, α-hydroxymethylethyl(meth)acrylate, polyethyleneglycol mono(meth)acrylate, polypropyleneglycol mono(meth)acrylate, polytetramethyleneglycol mono(meth)acrylate, polyethyleneglycol polytetramethyleneglycol mono(meth)acrylate, and the like, but not limited thereto. These kinds of hydroxyl group containing monomers may improve crosslinking density when a paint film is formed, and thus, properties such as hardness and the like of the paint film may become excellent. The ratio of the (meth)acrylic acid ester, carboxylic group containing monomers and hydroxyl group containing monomers is not specifically limited, but the ratio may be preferably 10˜70:5˜50:5˜40 by weight. The acrylic resin may be obtained by introducing the (meth)acrylic acid ester, carboxyl group containing monomers and hydroxyl group containing monomers, and optionally, various additives such as an initiator, and the like, in a solvent, and then, conducting thermal or photo polymerization, but not limiter thereto.

Thus obtained acrylic resin preferably has a hydroxyl value of about 10˜120 mgKOH/g. If the acrylic resin has a hydroxyl value within the above range, compatibility with ceramic resin may be good, and a curing density with ceramic resin and melamine resin may increase when cured at high temperature to harden the paint film.

Further, the acrylic resin may have a solid content of about 40˜70 wt % based on the total weight of the acrylic resin, and viscosity of about 1500˜3000 cps.

The melamine resin (a2) may cause a curing reaction between the hydroxyl group in the acrylic resin and the hydroxyl group in the ceramic resin, and harden the paint film to be formed, thereby increasing the surface hardness of the paint film. The melamine resin is obtained by the polymerization of alcohol and formaldehyde, and for example, methoxy melamine resin may be obtained by polymerization of methanol and formaldehyde; and butoxy melamine resin may be obtained by polymerization of isobutanol or normalbutanol and formaldehyde.

Non-limiting examples of the melamine resin that can be used in the present invention may include CYMEL-303, CYMEL-325, CYMEL-327, CYMEL-350, CYMEL-370 (CYTEC Industries Inc.), RESIMINE-7550, RESIMINE-717, RESIMINE-730, RESIMINE-747, RESIMINE-797 (SOLUTIA Inc.), BE-3717, BE-370, BE-3747 (BIP Co.), BE-630, BE-692 (BIP Co.), RESIMINE-7512, RESIMINE-750 (SOLUTIA Inc.), RESIMINE-755, RESIMINE-757, RESIMINE-751 (SOLUTIA Inc.), CYMEL-1168, CYMEL-1170, CYMEL232 (CYTEC Industries Inc.), and the like. According to one example of the present invention, as the melamine resin, CYMEL-303 manufactured from CYTEC Industries Inc. is used. Further, the organic resin of the present invention comprises epoxy resin (a3) to increase adhesion to a substrate and increase a curing density with the melamine resin. As the organic resin of the present invention comprises the epoxy resin, a crosslinking density with the melamine resin may increase at curing, thus improves properties of the paint such as adhesion.

Examples of the epoxy resin (a3) may include a glycidylether type epoxy resin, a glycidylamine type epoxy resin, a cycloaliphatic epoxy resin, a glycidylester type resin, a heterocyclic epoxy resin, an urethane modified epoxy resin, and the like, and more specifically, the glycidylether type epoxy resin may include bisphenol A type, bisphenol F type, bromide bisphenol A type, hydrogenated bisphenol A type, bisphenol S type, bispheol AF type, biphenyl type, naphthalene type, fluorene type, phenol novolac type, cresol novolac type, DPP novolac type, three-functional type, trishydroxyphenylmethane type, tetraphenylolethanol type, and the like, and the glycidyl amine type epoxy resin may include tetraglycidyl diaminodiphenylmethane, triglycidyl isocyanurate, hydantoin type, 1,3-bis(N,N-diglycidylaminomethyl)cyclohexane, aminophenol type, aniline type, toluidine type, and the like, but not limited thereto.

It may be preferable to use the epoxy resin having an epoxy equivalent of about 500 to 2,000 g/eq so as to form a paint film with excellent surface hardness.

The organic resin of the present invention may preferably comprise the acrylic resin (a1), melamine resin (a2) and epoxy resin (a3) in the weight ratio of a1:a2:a3=40˜60:10˜50:5˜30, so that the properties of a paint film including surface hardness, scratch resistance, adhesion to a substrate, gloss, and the like may be generally improved. The organic resin comprising the acrylic resin, melamine resin and epoxy resin in the above ratio may have a solid content of about 40˜70 wt % based on the total weight of the organic resin.

The organic resin has a glass transition temperature (Tg) of about 20˜70° C., which is lower than the conventional resin, by blending the acrylic resin, melamine resin and expoxy resin. Due to the low glass transition temperature, when a paint film is formed with the paint composition of the present invention, crosslinking density with ceramic resin is increased to improve general properties including gloss, adhesion, boil resistance, chemical resistance, and the like, as well as surface hardness and scratch resistance of the paint film.

And, each weight average molecular weight (Mw) of the acrylic resin, melamine resin and epoxy resin may be controlled so that the weight average molecular weight (Mw) of the organic resin may become 8,000˜30,000. For example, the weight average molecular weight of the acrylic resin may be about 10,000˜150,000, the weight average molecular weight of the melamine resin may be about 500˜5,000, and the weight average molecular weight of the epoxy resin may be about 2,000˜6,000. Thereby, the paint film formed with the paint composition of the present invention may have high surface hardness and excellent scratch resistance.

The content of the organic resin may be appropriately controlled considering the properties of the paint film to be formed, such as surface hardness, scratch resistance, gloss, and the like, and it may be preferably about 10˜30 parts by weight based on 100 parts by weight of the paint composition.

### Ceramic Resin

The organic-inorganic paint composition according to the present invention comprises ceramic resin (b) together with the above explained organic resin (a). The ceramic resin is formed by a sol-gel reaction. In general, a sol-gel reaction is a process of preparing ceramic resin at relatively low temperature by hydrolysis and condensation, wherein sol of colloidal suspension state continues to react to form a network or a polymer chain where the compositional ingredients of the sol are interconnected by chemical, physical bonding, thus turning to a gel state without fluidity.

The ceramic resin formed by the sol-gel reaction needs not to be cured at high temperature like the conventional porcelain enamel or water glass, and it may be cured at about 100 to 200° C., which is the general curing temperature of an organic paint. And, the ceramic resin may be easily cured even at low temperature because monosilane is hydrolyzed and dealcoholization is conducted. Thus, the paint composition of the present invention may be easily cured at a temperature of about 100˜200° C. without a curing accelerator such as a metal catalyst, unlike the conventional paint composition comprising silicon resin. Moreover, since the ceramic resin contains a hydroxyl group (—OH), it may easily chemically bond to organic resin, and thereby, a crosslinking density with organic resin is improved at curing, thus forming a paint film with excellent surface hardness and scratch resistance. In addition, the formed paint film has excellent properties including appearance, adhesion to a substrate such as interior and exterior furnishings, chemical resistance, and the like.

The ceramic resin (b) may be obtained by various methods. However, in the present invention, to further improve crosslinking density with the organic resin, it is preferred to use ceramic resin obtained by a sol-gel reaction of colloidal silica and alkoxysilane.

For example, the ceramic resin of the present invention may be prepared by gradually dripping alkoxysilane and optionally an organic solvent to colloidal silica and conducting hydrolysis and condensation; or it may be prepared by i) adding an acid catalyst to colloidal silica to adjust the pH to about 2˜3; and ii) gradually dripping alkoxysilane and optionally an organic solvent to the solution obtained in step i) and conducting hydrolysis and condensation.

The colloidal silica refers to a state wherein silica is dispersed in a solvent, such as water (H₂O), and the size of the silica particle is very small as several nm˜several hundreds of nm, and thus the silica particles can do Brown Movement with little influence by gravity.

The colloidal silica may have a solid content of 20 to 40 wt % based on the total weight of the colloidal silica, although not specifically limited.

And, the colloidal silica may have a silica particle size of about 5 to 50 nm, preferably 10 to 30 nm.

The colloidal silica may preferably have pH of about 6.5 to 8.5, although not specifically limited.

Examples of the acid catalyst may include acetic acid, phosphoric acid, and the like. Although hydrolysis commonly occurs without adding the acid catalyst, hydrolysis may rapidly and completely occur by adding the acid catalyst to control the pH of the solution to about 2 to 3.

The acid catalyst may be preferably used in an amount of about 2 to 5 parts by weight based on 100 parts by weight of the colloidal silica containing solution, in order to control the pH of the colloidal silica containing solution to about 2 to 3.

The alkoxysilane used in the present invention, as shown in the following Reaction Formula, undergoes hydrolysis with water to substitute the reactive group of the silane with a hydroxyl group (—OH), thus forming a silanol, and the formed silanol undergoes condensation with another silanol to form a structure of Si—O—Si—O—, and simultaneously, chemically and physically bonds with colloidal silica, thus forming ceramic resin having a continuous network structure of a gel state. If the ceramic resin is cured together with organic resin when a paint film is formed, a paint film with high hardness having a structure of O—(Si—O—Si)—O may be formed through condensation between the hydroxyl group (—OH) of the ceramic resin and the hydroxyl group of the organic resin.

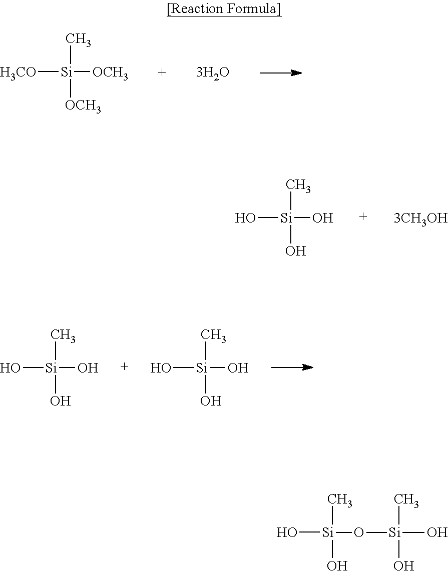

Examples of the alkoxysilane may include C₁˜C₆ alkoxysilane containing a C₁˜C₁₀ alkyl group; C₁˜C₆ alkoxysilane containing a glycidyl group; C₁˜C₆ alkoxysilane containing an acryl group; and C₁˜C₆ alkoxysilane containing two or more kinds of functional groups selected from a C₁˜C₁₀ alkyl group and an acryl group, but not limited thereto. They may be used alone or in combination, and preferably, C₁˜C₆ alkoxysilane containing a glycidyl group, C₁˜C₆ alkoxysilane containing a C₁˜C₁₀ alkyl group and C₁˜C₆ alkoxysilane containing an acryl group may be combined and used, or C₁˜C₆ alkoxysilane containing both a C₁˜C₁₀ alkyl group and an acrylic group may be used.

Specific examples of the alkoxy silane may include methyltrimethoxysilane, tetramethoxysilane, tetraethoxysilane, methacryltriethoxysilane, glycidyltriethoxysilane, and the like.

The molar ratio of the colloidal silica (α) and the alkoxysilane (β) may be preferably α:β=20˜50:50˜80. If the colloidal silica and the alkoxysilane are mixed in the above molar ratio, hydrolysis reactivity and storage stability may be good, and the properties of the paint may be good.

Meanwhile, in the present invention, an organic solvent may selectively be used to control the reaction speed, and the like, when using alkoxysilane mixed with the colloidal silica. The organic solvent that can be used is not specifically limited, but an alcohol solvent having excellent reaction speed controlling performance and storage stability may be preferably used. Examples of the alcohol solvent may include isopropyl alcohol, methylalcohol, ethylalcohol, methanol, ethanol, and the like, but not limited thereto.

The content of the organic solvent is not specifically limited, but preferably, the weight ratio of alkoxysilane:organic solvent may be 3˜5:1.

The content of the ceramic resin formed by the sol-gel reaction may be appropriately controlled considering surface hardness, scratch resistance, gloss, and the like of the paint film, and it may be preferably about 30˜80 parts by weight based on 100 parts by weight of the paint composition.

### Solvent

The solvent that can be used in the present invention is not specifically limited as long as it may uniformly dissolve the organic resin and the ceramic resin and control flowability of the paint composition. Non-limiting examples of the solvent may include alcohols such as isopropyl alcohol, methylalcohol, ethylalcohol, methanol, ethanol, normal-propanol, butanol, isobutanol, and the like, toluene, xylene, methylehtylketone, methylisobutylketone, methyl cellosolve, ethyl cellosolve, butyl cellosolve, butylacetate, propyleneglycol, and the like. They may be used alone or in combination, and it may be preferably used considering coatability, appearance of the product, and production yield.

The content of the solvent may be remaining content controlling the total amount of the paint composition to 100 parts by weight, considering workability and storage stability of the paint composition, and preferably it may be about 10˜30 parts by weight.

In addition to the above explained ingredients, the paint composition of the present invention may further comprise any additives, for example, diluent, a surface conditioner, a viscosity controlling agent, a thickner, an antioxidant, an UV stabilizer, an antifoaming agent, and the like. These additives may be added to the composition in an amount known to one of ordinary knowledge in the art.

Meanwhile, the organic-inorganic hybrid paint composition may be obtained by introducing the organic resin, the melamine resin, and optionally various additives such as diluent, and the like in a solvent, and then, dispersing the mixture. The organic-inorganic paint composition may preferably comprise (a) 10˜30 parts by weight of the organic resin; (b) 30˜80 parts by weight of the melamin resin; and (c) remaining amount of the solvent, based on 100 parts by weight of the paint composition.

The paint composition of the present invention may be used for anywhere a hard coating layer is required, such as a mobile phone case, exterior furnishings of household appliances, interior and exterior furnishings of automobile parts, interior and exterior furnishings of buildings.

A method of forming a hard coating layer on the surface of a substrate such as plastic, metal, glass, wood, tile, ceramic, and the like is not specifically limited, and for example, the hard coating layer may be formed by sufficiently cleaning a substrate, preheating it by UV irradiator to remove remaining oil and foreign substances, coating the paint composition on the surface of the substrate, drying at a temperature of about 150˜180° C. to remove the solvent, and heat curing.

The coating method may include dip coating, spray coating, flow coating, roll coating, gravure coating, and the like.

The thickness of the coating layer may be appropriately controlled according to the kind of the substrate or purpose of the paint film, and for example, it may be 15˜40 μm.

Hereinafter, the present invention will be explained with reference to examples and comparative examples. However, the following examples are only to illustrate the invention, and the scope of the invention is not limited thereto. Hereinafter, parts by weight is based on 100 parts by weight of a composition for forming acrylic resin, a composition for forming organic resin, a composition for inorganic resin or a paint composition.

### Preparation Example 1

### Preparation of Organic Resin 1

40 parts by weight of an organic solvent obtained by mixing toluene and normal butyl acetate in the weight ratio of 10:30 was introduced in a reaction flask, and then, the reaction mixture was heated to a temperature of about 120° C. Then, to the reaction flask, monomers including 18 parts by weight of methylmethacrylate, 12 parts by weight of butyl acrylate, 16 parts by weight of 2-hydroxy methacrylate, 7 parts by weight of methacrylic acid and 7 parts by weight of an organic peroxide initiator, benzoyl peroxide were gradually dripped, to obtain acrylic resin having a solid content of 60 wt % based on the total weight of the acrylic resin, and viscosity of 1900 cps (weight average molecular weight: 18,000).

48 parts by weight of the obtained acrylic resin was introduced in a dilution solvent of 12 parts by weight of toluene and 10 parts by weight of methylisobutylketone, together with 20 parts by weight of melamine resin (CYMEL 325 from CYTEC Industries Inc.) and 10 parts by weight of epoxy resin (YD 128 from Kukdo Chemical Co. Ltd.), to obtain organic resin 1 having a solid content of 60 wt % based on the total weight of the organic resin. The obtained organic resin 1 had a weight average molecular weight of 12,000, and a glass transition temperature of 45° C., and a hydroxyl value of 70 mg KOH/g.

### Preparation Example

### Preparation of Organic Resin 2

40 parts by weight of an organic solvent obtained by mixing toluene and normal butyl acetate in the weight ratio of 10:30 was introduced in a reaction flask, and then, the reaction mixture was heated to a temperature of about 120° C. Then, to the reaction flask, monomers including 20 parts by weight of methylmethacrylate, 8 parts by weight of ethyl acrylate, 20 parts by weight of 2-hydroxy methacrylate, 6 parts by weight of methacrylic acid and 6 parts by weight of benzoyl peroxide were gradually dripped, to obtain acrylic resin having a solid content of 60 wt % based on the total weight of the acrylic resin, and viscosity of 2600 cps (weight average molecular weight: 22,000).

42 parts by weight of the obtained acrylic resin was introduced in a dilution solvent of 12 parts by weight of toluene and 10 parts by weight of methylisobutyl ketone, together with 26 parts by weight of melamine resin (CYMEL 325 from CYTEC Industries Inc.) and 10 parts by weight of epoxy resin (YD 128 from Kukdo Chemical Co. Ltd.), to obtain organic resin 2 having a solid content of 60 wt % based on the total weight of the organic resin. The obtained organic resin 2 has a weight average molecular weight of 14,000, a glass transition temperature of 50° C., and a hydroxyl value of 80 mg KOH/g.

### Preparation Example 3

### Preparation of Inorganic Resin 1

To 30 parts by weight of colloidal silica (SN-SOL of Japan, Catalysts & Chemicals Industries Co. Ltd.), 1 part by weight of acetic acid was added to control the pH to about 2-3, and then, while gradually adding 50 parts by weight of methyltrimethoxy silane and 19 parts by weight of isopropylalcohol thereto at room temperature (about 10˜30° C.), hydrolysis and condensation were progressed to obtain ceramic resin having a solid content of 40 wt % based on the total weight of the ceramic resin.

### Preparation Example 4

### Preparation of Inorganic Resin 2

To 30 parts by weight of colloidal silica (SN-SOL of Japan, Catalysts & Chemicals Industries Co. Ltd.), 1 part by weight of acetic acid was added to control the pH to about 2˜3, and then, while gradually adding 45 parts by weight of methyltrimethoxy silane, 10 parts by weight of tetraethoxysilane, and 14 parts by weight of isopropylalcohol thereto at room temperature (about 10˜30° C.), hydrolysis and condensation were progressed to obtain ceramic resin having a solid content of 45 wt % based on the total weight of the ceramic resin.

### Preparation Example 5

### Preparation of Inorganic Resin 3

To 24 parts by weight of colloidal silica (SN-SOL of Japan, Catalysts & Chemicals Industries Co. Ltd.), 1 part by weight of acetic acid was added to control the pH to about 2˜3, and then, while gradually adding 46 parts by weight of methyltrimethoxy silane, 5 parts by weight of methacryltriethoxysilane, and 24 parts by weight of glycidyltriethoxysilane thereto at room temperature (about 10˜30° C.), hydrolysis and condensation were progressed to obtain ceramic resin having a solid content of 45 wt % based on the total weight of the ceramic resin.

### Example 1

18 parts by weight of the organic resin 1 obtained in Preparation Example 1 and 56 parts by weight of the inorganic resin 1 obtained in Preparation Example 3 were mixed. To the mixture, 12 parts by weight of normal butyl acetate, 6 parts by weight of methyl isobutyl ketone and 4 parts by weight of butyl cellosolve as diluents, 2 parts by weight of TEGO 410 as a wetting dispersant, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 20 μm, and cured at about 150° C. for about 30 minutes to form a paint film on the surface of the substrate.

### Example 2

18 parts by weight of the organic resin 1 obtained in Preparation Example 1 and 56 parts by weight of the inorganic resin 2 obtained in Preparation Example 4 were mixed. To the mixture, 14 parts by weight of normal butyl acetate, 5 parts by weight of methyl isobutyl ketone and 3 parts by weight of butyl cellosolve as diluents, 2 parts by weight of TEGO 410 as a wetting agent, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 21 μm, and cured at about 150° C. for about 30 minutes to form a paint film on the surface of the substrate.

### Example 3

18 parts by weight of the organic resin 1 obtained in Preparation Example 1 and 56 parts by weight of the inorganic resin 3 obtained in Preparation Example 5 were mixed. To the mixture, 13 parts by weight of normal butyl acetate, 6 parts by weight of methyl isobutyl ketone and 3 parts by weight of butyl cellosolve as diluents, 2 parts by weight of TEGO 410 as a wetting agent, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 21 μm, and cured at about 150° C. for about 30 minutes to form a paint film on the surface of the substrate.

### Example 4

18 parts by weight of the organic resin 2 obtained in Preparation Example 2 and 56 parts by weight of the inorganic resin 1 obtained in Preparation Example 3 were mixed. To the mixture, 12 parts by weight of normal butyl acetate, 6 parts by weight of methyl isobutyl ketone and 4 parts by weight of butyl cellosolve as diluents, 2 parts by weight of TEGO 410 as a wetting agent, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 20 μm, and cured at about 150° C. for about 30 minutes to form a paint film on the surface of the substrate.

### Example 5

18 parts by weight of the organic resin 2 obtained in Preparation Example 2 and 56 parts by weight of the inorganic resin 2 obtained in Preparation Example 4 were mixed. To the mixture, 14 parts by weight of normal butyl acetate, 5 parts by weight of methyl isobutyl ketone and 3 parts by weight of butyl cellosolve as diluents, 2 parts by weight of TEGO 410 as a wetting agent, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 20 μm, and cured at about 150° C. for about 30 minutes to form a paint film on the surface of the substrate.

### Example 6

18 parts by weight of the organic resin 2 obtained in Preparation Example 2 and 56 parts by weight of the inorganic resin 3 obtained in Preparation Example 5 were mixed. To the mixture, 13 parts by weight of normal butyl acetate, 6 parts by weight of methyl isobutyl ketone and 3 parts by weight of butyl cellosolve as diluents, 2 parts by weight of TEGO 410 as a wetting agent, and 2 parts by weight of FC-4430 as a fluorosurfactant were added, and then, agitated to obtain an organic-inorganic hybrid paint composition.

Then, the obtained organic-inorganic hybrid paint composition was spray coated on an SUS substrate to a thickness of 20 μm, and cured at about 150° C. for about 30 minutes to form a paint film on the surface of the substrate.

### Comparative Example 1

18 parts by weight of the organic resin 2 obtained in Preparation Example 2 and 56 parts by weight of the silicon resin (z-6018 of Dow Coming) were mixed. To the mixture, 13 parts by weight of normal butyl acetate, 6 parts by weight of methyl isobutyl ketone and 3 parts by weight of butyl cellosolve as diluents, 2 parts by weight of TEGO 410 as a wetting dispersant, 2 parts by weight of FC-4430 as a fluorosurfactant, and 2 parts by weight of Zr Octate (12%) as a curing accelerator were added, and then, agitated to obtain a paint composition.

Then, the obtained paint composition was spray coated on an SUS substrate to a thickness of 20 μm, and cured at about 150° C. for about 30 minutes to form a paint film on the surface of the substrate.

The obtained paint film on the SUS substrate was partially yellowed, had low pencil hardness of 3H, and failed in a rubbing test.

### Experimental Example 1

### Property Evaluation

The properties of the paint films formed using the paint compositions of Examples 1 to 6 and Comparative Example 1 were evaluated by the following test method. The results are described in Table 2.

### Adhesion

On the paint film formed on the SUS substrate, C-cutting was made at an interval of 1 mm using a sharp knife, and then, a cellophane tape is attached, and the tape was strongly pulled in 90° direction to the substrate to evaluate whether or not the paint film was delaminated. If there is no delamination of the paint film, it is marked as “OK”, and if there is delamination of the paint film, it is marked as “NG”.

### Pencil Hardness

On the paint film formed on the SUS substrate, line was drawn while maintaining an angle of 45° under a load of 1 kg to evaluate the degree of scratch of the paint film according to the kinds of pencils (B, HB, F, H, 2H, 3H, 4H, and the like). The maximum strength when scratch is not generated on the paint film was marked as a pencil hardness, and test was repeated 5 times per one sample and if scratch is not generated 3 or more times, it was marked as the pencil hardness of the sample. The degree of scratch was marked in the order of (Soft) B->HB->F->H->2H->3H->4H->F (Hard), namely by the kinds of pencils at maximum strength.

### Boil Resistance

The SUS substrate on which a paint film is formed was immersed in water of 98˜100° C. for 1 hour, and then, it was taken out and allowed to stand at room temperature for 1 hour. After blistering or X-cutting of the surface of the paint film, a cellophane tape was attached, and then, the tape was strongly pulled in 90° direction to the paint film to evaluate whether or not the surface was delaminated. If there is no delamination of the paint film, it was marked as “OK”, and if there is delamination of the paint film, it was marked as “NG”.

### Gloss

Gloss was evaluated by measuring a 60° specular reflection value using a glossmeter.

### Precipitation Test

The SUS substrate on which a paint film is formed was allowed to stand in a space of temperature of 80° C. and humidity of 80% for 2 hours, and allowed to stand at room temperature for 1 hour, and then, X-cross cutting was conducted to confirm whether or not the paint film was delaminated. If there is no delamination of the paint film, it was marked as “OK”, and if there is delamination of the paint film, it was marked a “NG”.

### Rubbing Test

The paint film on the SUS substrate was rubbed with an alcohol-coated cloth under a load of 1 kgf for 25 times per minute (back and forth 1 time) to confirm whether or not the paint film peeled. If there is no peeling of the paint film, it was marked as “OK”, and if there is peeling of the paint film, it was marked as “NG”.

TABLE 1

| | | | | | | | Comparative |
|---|---|---|---|---|---|---|---|
| | Example 1 | Example 2 | Example 3 | Example 4 | Example 5 | Example 6 | Example 1 |
| Adhesion | OK | NG | OK | OK | OK | OK | OK |
| Pencil | 3H | 4H | 4H | 4H | 5H | 5H | 3H |
| hardness | | | | | | | |
| Boiling | NG | OK | OK | NG | OK | OK | NG |
| resistance | | | | | | | |
| Gloss | 91 | 91 | 92 | 91 | 92 | 91 | 96 |
| Precipitation | NG | OK | OK | OK | OK | OK | NG |
| test | | | | | | | |
| Rubbing | OK | OK | OK | OK | OK | OK | NG |
| test | | | | | | | |

As can be seen from the Table 1, the paint film formed using the paint composition of Comparative Example 1 had excellent gloss but low pencil hardness of 3H, and showed delamination or peeling. To the contrary, the paint films formed using the paint compositions of Examples 1˜6 exhibited generally excellent properties in terms of all evaluation test items. Particularly, the paint films formed using the paint compositions of Examples 5 and 6 exhibited very excellent hardness with the pencil hardness of 5H, and did not show delamination or peeling.

Therefore, it can be seen that when a paint film is formed using the organic-inorganic hybrid paint composition of the present invention, hardness of the paint film is high and scratch resistance is excellent compared to a paint film formed using a conventional paint composition comprising silicon resin, and it generally satisfies reliability required in this field.

1. An organic-inorganic hybrid paint composition comprising
(a) an organic resin comprising an acrylic resin, a melamine resin and an epoxy resin;
(b) a ceramic resin; and
(c) a solvent.

2. The organic-inorganic hybrid paint composition of claim 1, wherein the paint composition comprises
10 to 30 parts by weight of the organic resin,
30 to 80 parts by weight of the ceramic resin, and
10 to 30 parts by weight of the solvent,
based on 100 parts by weight of the paint composition.

3. The organic-inorganic hybrid paint composition of claim 1, wherein the organic resin comprises the acrylic resin, the melamine resin and the epoxy resin in the ratio of 40 to 60:10 to 50:5 to 30 by weight.

4. The organic-inorganic hybrid paint composition of claim 1, wherein the organic resin has a weight average molecular weight (Mw) of 8,000 to 30,000, glass transition temperature (T_{g}) of 20 to 70° C., and a solid content of 40 to 70 wt % based on the total weight of the organic resin.

5. The organic-inorganic hybrid paint composition of claim 1, wherein the ceramic resin is formed by hydrolysis and condensation of a colloidal silica (α) and an alkoxysilane (β).

6. The organic-inorganic hybrid paint composition of claim 5, wherein the alkoxysilane is selected from the group consisting of a C₁-C₆ alkoxysilane containing a glycidyl group; a C₁-C₆ alkoxysilane containing a C₁-C₁₀ alkyl group; a C₁-C₆ alkoxysilane containing an acryl group; and a C₁-C₆ alkoxysilane containing a functional group selected from a glycidyl group, a C₁-C₁₀ alkyl group, and an acryl group.

7. The organic-inorganic hybrid paint composition of claim 5, wherein the ratio of the colloidal silica (α) to the alkoxysilane (β) is α:β=20-50:50-80 by weight.

8. The organic-inorganic hybrid paint composition of claim 2, wherein the organic resin comprises the acrylic resin, the melamine resin and the epoxy resin in the ratio of 40 to 60:10 to 50:5 to 30 by weight.

9. The organic-inorganic hybrid paint composition of claim 2, wherein the organic resin has a weight average molecular weight (Mw) of 8,000 to 30,000, glass transition temperature (T_{g}) of 20 to 70° C., and a solid content of 40 to 70 wt % based on the total weight of the organic resin.

10. The organic-inorganic hybrid paint composition of claim 3, wherein the organic resin has a weight average molecular weight (Mw) of 8,000 to 30,000, glass transition temperature (T_{g}) of 20 to 70° C., and a solid content of 40 to 70 wt % based on the total weight of the organic resin.

11. The organic-inorganic hybrid paint composition of claim 2, wherein the ceramic resin is formed by hydrolysis and condensation of a colloidal silica (α) and an alkoxysilane (β).

12. The organic-inorganic hybrid paint composition of claim 3, wherein the ceramic resin is formed by hydrolysis and condensation of a colloidal silica (α) and an alkoxysilane (β).

13. The organic-inorganic hybrid paint composition of claim 4, wherein the ceramic resin is formed by hydrolysis and condensation of a colloidal silica (α) and an alkoxysilane (β).

14. The organic-inorganic hybrid paint composition of claim 11, wherein the alkoxysilane is selected from the group consisting of a C₁-C₆ alkoxysilane containing a glycidyl group; a C₁-C₆ alkoxysilane containing a C₁-C₁₀ alkyl group; a C₁-C₆ alkoxysilane containing an acryl group; and a C₁-C₆ alkoxysilane containing a functional group selected from a glycidyl group, a C₁-C₁₀ alkyl group, and an acryl group.

15. The organic-inorganic hybrid paint composition of claim 12, wherein the alkoxysilane is selected from the group consisting of a C₁-C₆ alkoxysilane containing a glycidyl group; a C₁-C₆ alkoxysilane containing a C₁-C₁₀ alkyl group; a C₁-C₆ alkoxysilane containing an acryl group; and a C₁-C₆ alkoxysilane containing a functional group selected from a glycidyl group, a C₁-C₁₀ alkyl group, and an acryl group.

16. The organic-inorganic hybrid paint composition of claim 13, wherein the alkoxysilane is selected from the group consisting of a C₁-C₆ alkoxysilane containing a glycidyl group; a C₁-C₆ alkoxysilane containing a C₁-C₁₀ alkyl group; a C₁-C₆ alkoxysilane containing an acryl group; and a C₁-C₆ alkoxysilane containing a functional group selected from a glycidyl group, a C₁-C₁₀ alkyl group, and an acryl group.

17. The organic-inorganic hybrid paint composition of claim 11, wherein the ratio of the colloidal silica (α) to the alkoxysilane ((62 ) is α:β=20-50:50-80 by weight.

18. The organic-inorganic hybrid paint composition of claim 12, wherein the ratio of the colloidal silica (α) to the alkoxysilane (β) is α:β=20-50:50-80 by weight.

19. The organic-inorganic hybrid paint composition of claim 13, wherein the ratio of the colloidal silica (α) to the alkoxysilane (β) is α:β=20-50:50-80 by weight.

20. The organic-inorganic hybrid paint composition of claim 6, wherein the ratio of the colloidal silica (α) to the alkoxysilane (β) is α:β=20-50:50-80 by weight.
